(19) United States
(12) Patent Application Publication
(10) Pub. No.: US 2021/0367338 A1
(43) Pub. Date: Nov. 25, 2021

(54) PHASED ARRAY ANTENNA

(71) Applicant: Japan Display Inc., Tokyo (JP)

(72) Inventor: Daiichi SUZUKI, Tokyo (JP)

(73) Assignee: Japan Display Inc., Tokyo (JP)

(21) Appl. No.: 17/394,951

(22) Filed: Aug. 5, 2021

Related U.S. Application Data
(63) Continuation of application No. PCT/JP2019/045859, filed on Nov. 22, 2019.

(30) Foreign Application Priority Data
Feb. 6, 2019 (JP) 2019-019239

(51) Int. Cl. H01Q 3/36

(52) U.S. Cl. CPC H01Q 3/36

(57) ABSTRACT

A phased array antenna includes a plurality of antenna elements, a plurality of phase shifters, each of the plurality of phase shifters is connected to each of the plurality of antenna elements, respectively, a phase control circuit for controlling the amount of phase shift of the plurality of phase shifters, and a temperature sensor for detecting the temperature of the plurality of phase shifters. The phase control circuit is configured to control a voltage applied to the plurality of phase shifters based on the temperature detected by the temperature sensor.

### CROSS-REFERENCE TO RELATED APPLICATIONS

This application is a Continuation of International Patent Application No. PCT/JP2019/045859, filed on Nov. 22, 2019, which claims priority to Japanese Patent Application No. 2019-019239, filed on Feb. 6, 2019, the disclosures of which are incorporated herein by reference for all purposes as if fully set forth herein.

### FIELD

An embodiment of the present invention relates to a technique for compensating for variations in the characteristics of a phased array antenna.

### BACKGROUND

In a phased array antenna, a high frequency signal is applied to a portion or all of a plurality of antenna elements. The phased array antenna can control the radiation directivity of the antenna while the direction of the antenna is fixed in one direction by controlling the amplitude and phase of each high frequency signal. The phased array antenna uses phase shifters to control the phase of high frequency signals applied to the antenna elements.

Various methods are employed for the phase shifter, such as a method of physically changing the length of the transmission line to change the phase of the high frequency signal, a method of changing the impedance in the middle of the transmission line to phase the high frequency by reflection, and a method of generating a signal having the desired phase by controlling and combining the gain of the amplifier that amplifies two signals having different phases. In addition, as an example of a phase shifter, a type which utilizes the characteristic properties of a liquid crystal material in which the dielectric constant varies with the applied voltage has been disclosed (Japanese Unexamined Patent Application Publication No. H11-103201).

### SUMMARY

A phased array antenna according to an embodiment of the present invention includes a plurality of antenna elements, a plurality of phase shifters, each of the plurality of phase shifters is connected to each of the plurality of antenna elements, respectively, a phase control circuit for controlling the amount of phase shift of the plurality of phase shifters, and a temperature sensor for detecting the temperature of the plurality of phase shifters. The phase control circuit is configured to control a voltage applied to the plurality of phase shifters based on the temperature detected by the temperature sensor.

### BRIEF DESCRIPTION OF DRAWINGS

FIG. 1 is a diagram showing a configuration of a phased array antenna according to an embodiment of the present invention;

FIG. 2 is a diagram showing a configuration of a phased array antenna according to an embodiment of the present invention;

FIG. 3 is a diagram showing a configuration of a phase shifter used in a phased array antenna according to an embodiment of the present invention;

FIG. 4 is a diagram showing a configuration of a phase shifter used in a phased array antenna according to an embodiment of the present invention;

FIG. 5A is a diagram for showing the operation of a phase shifter used in a phased array antenna according to an embodiment of the present invention, and shows a state in which no voltage is applied to a liquid crystal layer;

FIG. 5B is a diagram showing the operation of a phase shifter used in a phased array antenna according to an embodiment of the present invention, and shows a state in which a voltage is applied to a liquid crystal layer;

FIG. 6A shows a graph showing the tunability of a phase shifter used in a phased array antenna according to an embodiment of the present invention, showing that tunability is maintained by setting a DC voltage in response to temperature;

FIG. 6B shows a graph showing the tunability of a phase shifter used in a phased array antenna according to an embodiment of the present invention and shows that tunability is maintained constant by setting a frequency in response to temperature; and

FIG. 7 shows a configuration of a phase control circuit used in a phased array antenna according to an embodiment of the present invention.

### DESCRIPTION OF EMBODIMENTS

Hereinafter, embodiments of the present invention will be described with reference to the drawings and the like. The present invention may be carried out in various forms without departing from the gist thereof, and is not to be construed as being limited to any of the following embodiments. Although the drawings may schematically represent the width, thickness, shape, and the like of each part in comparison with the actual embodiment in order to clarify the description, they are merely examples and do not limit the interpretation of the present invention. In the present specification and each of the figures, elements similar to those described above with respect to the figures mentioned above are designated by the same reference numerals (or numbers followed by a, b, etc.), and a detailed description thereof may be omitted as appropriate. Furthermore, the characters “first” and “second” appended to each element are convenient signs used to distinguish each element, and have no further meaning unless specifically described.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

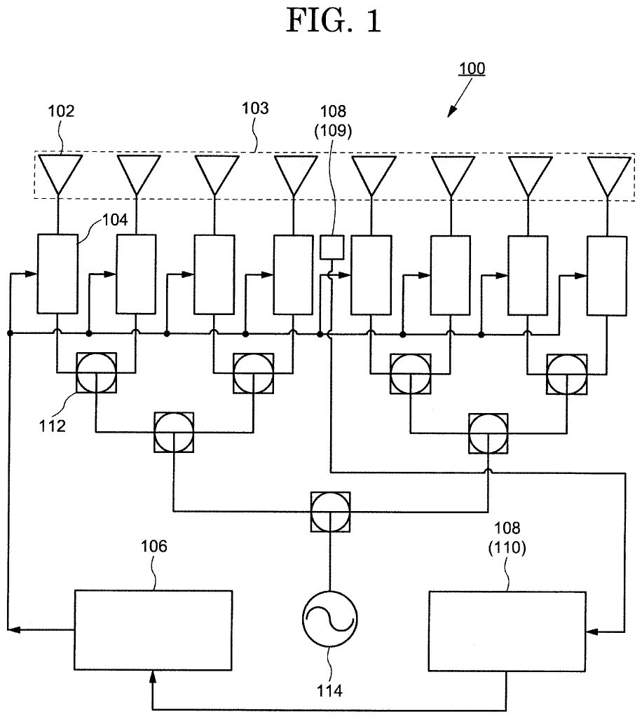

FIG. 1 shows an example of a configuration of a phased array antenna 100 according to this embodiment. The phased array antenna 100 includes an antenna element 102, a phase shifter 104, a phase control circuit 106 for controlling the amount of phase shift of the phase shifter 104, and a temperature sensor 108 for sensing the temperature of the phase shifter 104. An antenna element array 103 is formed by disposing a plurality of antenna elements 102 in a linear, circular or planar fashion. The phase shifter 104 is connected in series with each of the plurality of antenna elements 102.

FIG. 1 shows the phased array antenna 100 for transmission. In this case, the phased array antenna 100 is connected to an oscillator 114. A high frequency signal output from the oscillator 114 is distributed by distributors 112 to the respective phase shifters 104.

The radio waves emitted from each of the plurality of antenna elements 102 have coherency. Therefore, the radio waves emitted from each of the plurality of antenna elements 102 form a phase-aligned wavefront. The phase shifter 104 adjusts the phase of the radio waves emitted from the antenna element 102. The phase shifter 104 controls the phase of the high frequency signal emitted as a radio wave by the phase control circuit 106. Here, the amount of phase shift of the high frequency signal controlled by the phase shifter 104 is referred to as an “amount of phase shift”.

The phased array antenna 100 individually adjusts the phase of the high frequency signal supplied by the phase control circuit 106 to each of the plurality of antenna elements 102 by the phase shifter 104. The direction of travel of the wavefront of radio waves emitted from the plurality of antenna elements 102 can be controlled at any angle. The phased array antenna 100 controls the directivity of the radiating radio waves by controlling the phase of each of the plurality of antenna elements 102.

On the other hand, the phase array antenna device 100 for reception is configured to provide a high frequency amplifier instead of the oscillator 114 to amplify the radio waves received by the plurality of antenna elements 102 and output the signal to a subsequent circuit, such as a demodulator circuit.

The temperature sensor 108 includes a sensing unit 109 and a measuring circuit 110. The sensing unit 109 is implemented by use of a non-contact type temperature sensor for detecting infrared intensity, or a contact type temperature sensor for detecting thermoelectric power, electrical resistance, or a change in magnetism, or the like. For example, a resistance temperature sensor is used in the sensing unit 109. For example, a thermistor or a platinum thin film temperature sensor may be used as the resistance temperature sensor. The sensing unit 109 is disposed such that at least one temperature of the phase shifter 104 is detectable. For example, the sensing unit 109 is disposed in contact with the phase shifter 104. The sensing unit 109 is also located adjacent to or close to the phase shifter 104. In other words, the sensing unit 109 is disposed to sense the temperature of the environment where the phase shifter 104 is located. In either case, the sensing unit 109 may be disposed to directly measure the temperature of the phase shifter 104, or it may be disposed to sense the temperature of the environment in which the plurality of phase shifters 104 are located as a substitute characteristic.

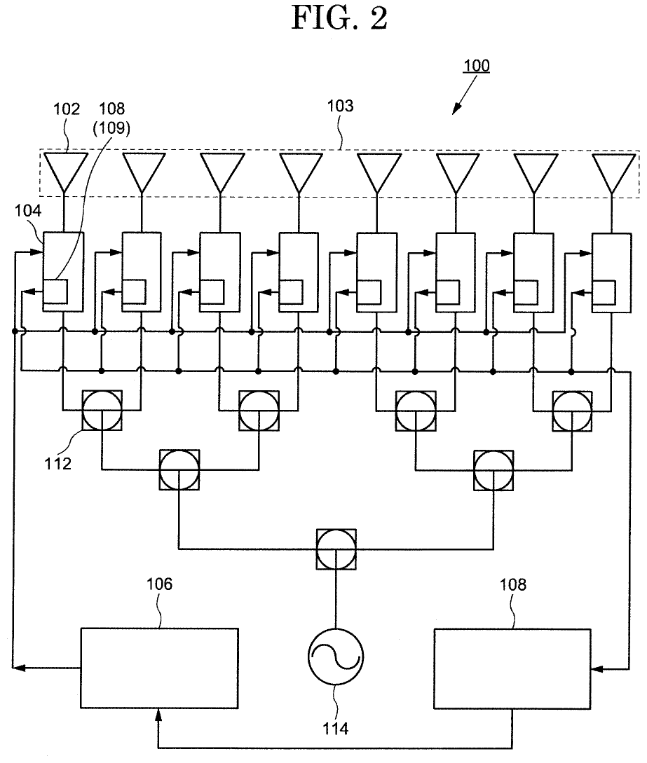

FIG. 1 shows an example in which one sensing unit 109 is disposed for a plurality of phase shifters 104. The sensing unit 109 is disposed to sense the temperature of the environment where the phase shifter 104 is located. The sensing unit 109 may also be disposed to sense the temperature of each phase shifter 104. According to the configuration shown in FIG. 1, the configuration of the phased array antenna 100 can be simplified. On the other hand, FIG. 2 shows an example in which the sensing unit 109 is disposed on each of a plurality of phase shifters 104. According to the configuration shown in FIG. 2, the temperature of each phase shifters 104 can be detected and precise temperature control can be performed.

The signal detected by the sensing unit 109 is input to the measurement circuit 110. The measurement circuit 110 converts the signal output from the sensing unit to temperature data and outputs it to the phase control circuit 106. The phase control circuit 106 outputs a control signal for controlling the amount of phase shift to each phase shifter 104. The phase control circuit 106 sets the setting value of the phase control signal according to the temperature so that the amount of phase shift of the phase shifter 104 does not vary with the temperature based on the temperature data input from the measurement circuit 110.

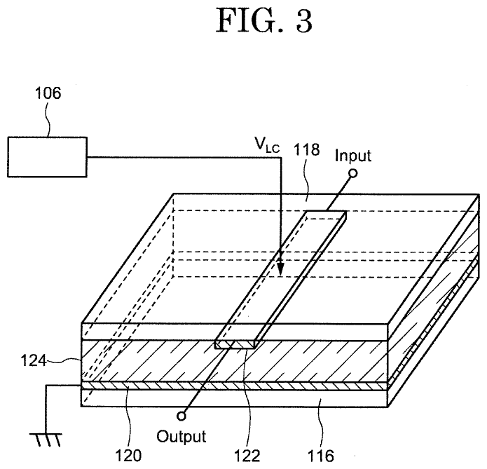

FIG. 3 is a perspective view showing the configuration of the phase shifter 104 according to the present embodiment. The phase shifter 104 has a configuration in which a first electrode 120 and a second electrode 122 forming a strip line are disposed to oppose each other with a gap, and a liquid crystal layer 124 is provided in the gap. The first electrode 120 is disposed on the first substrate 116 and the second electrode 122 is disposed on the second substrate 118. The first substrate 116 and the second substrate 118 are facing each other with a constant gap, and the liquid crystal layer 124 is provided in the gap between the first substrate 116 and the second substrate 118.

The first electrode 120 is formed of a conductor pattern extending substantially over the first substrate 116. The second electrode 122, on the other hand, is formed of an elongated, strip-like conductor pattern to form a microstrip line. The first electrode 120 is applied with a constant potential. For example, the first electrode 120 is grounded. One longitudinal direction of the second electrode 122 serves as the input terminal of the high frequency signal and the other as the output terminal of the high frequency signal. The liquid crystal layer 124 is provided to fill at least a region between the first electrode 120 and the second electrode 122. Although not shown in FIG. 3, spacers may be disposed between the first substrate 116 and the second substrate 118 so as to maintain a constant gap. Although not shown in FIG. 3, the first substrate 116 and the second substrate 118 may be laminated with a sealant to seal the liquid crystal layer 124.

A liquid crystal material is used as the liquid crystal layer 124. As the liquid crystal material, nematic liquid crystal, smectic liquid crystal, cholesteric liquid crystal, discotic liquid crystal, and ferroelectric liquid crystal (for example, chiral smectic liquid crystal) can be used.

A control signal is applied to the second electrode 122 from the phase control circuit 106. The control signal is a DC or AC voltage signal. Preferably, the DC voltage signal is a polarity reversing signal which has a polarity that is reversed over time. When the control signal is applied to the second electrode 122, the liquid crystal layer 124 changes the orientation of the liquid crystal molecule according to the potential difference between the first electrode 120 and the second electrode 122. Since the liquid crystal molecule is a polar molecule, the dielectric constant of the liquid crystal layer 124 varies depending on the orientation of the liquid crystal molecule. That is, the phase shifter 104 can vary the dielectric constant by the voltage applied to the second electrode 122.

The dielectric constant of the liquid crystal material varies depending on the temperature. Accordingly, the phase shifter using a liquid crystal material changes the amount of phase shift depending on temperature. Thus, the challenge is to vary the directivity of the phased array antenna in response to changes in temperature.

In order to overcome these problems and precisely control the amount of phase shift of the high frequency signal propagated by the phase shifter 104, it is preferred that the control signal applied to the second electrode 122 be compensated for according to the temperature characteristics of the liquid crystal layer 124. The phased array antenna 100 has the function of detecting the temperature of the phase shifter 104 by the temperature sensor 108, as described with reference to FIG. 1. The phase control circuit 106 has the function of outputting a temperature compensated control signal to the phase shifter 104 by inputting the temperature of the phase shifter 104 detected by the temperature sensor 108.

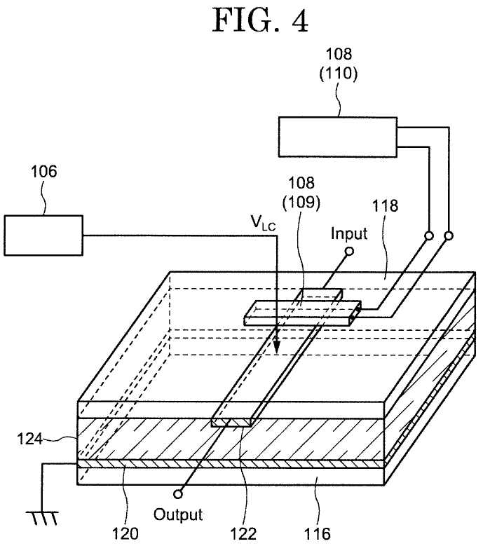

FIG. 4 shows an embodiment in which the sensing unit 109 is disposed in the phase shifter 104. The sensing unit 109 is disposed in close proximity to the phase shifter 104. FIG. 4 shows an embodiment in which the sensing unit 109 is disposed in close proximity to the second substrate 118. In such a case, a thin film temperature sensor is preferably used for the sensing unit 109. For example, a platinum thin film temperature sensor can be used as the thin film temperature sensor. As described above, the temperature of the liquid crystal layer 124 can be measured in a closer proximity state by using an adhesive type of temperature sensor as the sensing unit 109. The configuration of the sensing unit 109 shown in FIG. 4 is suitable in the case where the phase shifter 104 is disposed individually in each phase shifter 104, as shown in FIG. 2. Although FIG. 4 shows an embodiment in which the sensing unit 109 is disposed in the second substrate 118, the sensing unit 109 may be disposed in the first substrate 116 or in both the first substrate 116 and the second substrate 118.

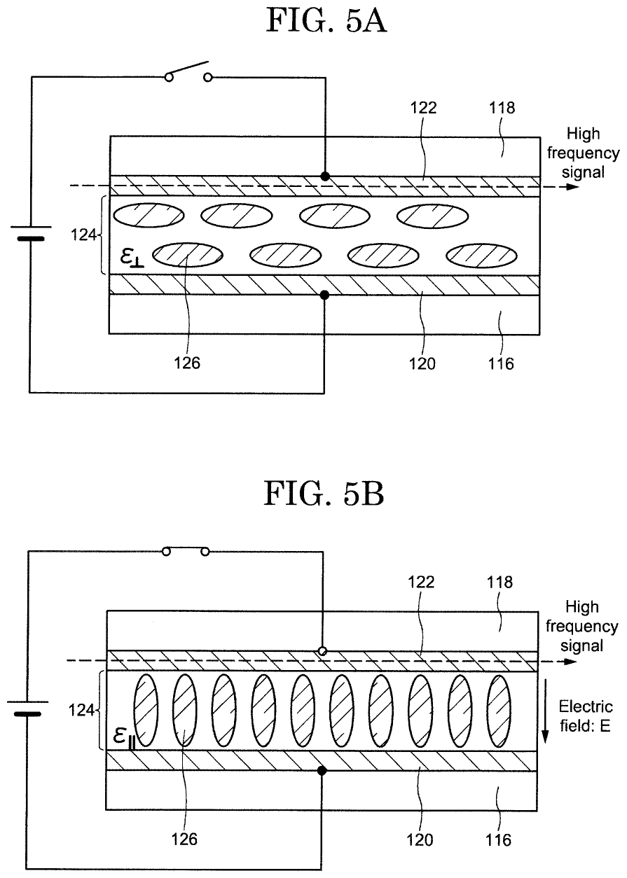

As described above, since the liquid crystal molecules are polar molecules and have dielectric constant anisotropy, the dielectric constant varies depending on the orientation state. FIG. 5A shows a first state in which no voltage is applied between the first electrode 120 and the second electrode 122. When the phase shifter 104 is in the first state, the liquid crystal molecule 126 is oriented in a longitudinal direction parallel to the main surface of the first substrate 116 and the second substrate 118. In FIG. 5A, when the high frequency signal propagates to the second electrode 122 forming the microstrip line, the longitudinal direction of the liquid crystal molecule 126 is oriented perpendicular to the high frequency electric field. FIG. 5A shows that in a first state, the liquid crystal layer 124 has a first dielectric constant (ε_{⊥}).

FIG. 5B, on the other hand, shows the second state in which a voltage is applied between the first electrode 120 and the second electrode 122. In the second state, the longitudinal direction of the liquid crystal molecule 126 is oriented perpendicular to the main surface of the first substrate 116 and the second substrate 118. In FIG. 5B, when the high frequency signal propagates to the second electrode 122, the longitudinal direction of the liquid crystal molecule 126 is oriented parallel to the high frequency electric field. FIG. 5B shows that in the second state, the liquid crystal layer 124 has a second dielectric constant (ε_{//}).

The second dielectric constant (ε_{//}) is larger than the first dielectric constant (ε_{⊥}) (ε_{⊥}<ε_{//}). This is because the liquid crystal molecules 126 in the second state are oriented in the direction perpendicular to the main surfaces of the first substrate 116 and the second substrate 118. The phase shifter 104 can vary the phase of the high frequency signal flowing through the second electrode 122 by changing the dielectric constant of the liquid crystal layer 124. For example, when the dielectric constant of the liquid crystal layer 124 increases, the phase velocity of the high frequency signal is slowed. Specifically, the phase shifter 104 changes from the first state to the second state, thereby delaying the phase of the high frequency signal propagating through the second electrode 122. Thus, it is possible to control the amount of phase shift of the high frequency signal by changing the voltage (DC voltage) applied to the second electrode 122.

Since the dielectric constant of the liquid crystal layer 124 is changed by the polarization of the liquid crystal molecules 126, the dielectric constant can be changed by applying an AC voltage to the second electrode 122 and changing its frequency. For example, when the frequency of the AC voltage applied to the second electrode 122 increases, the liquid crystal molecule 126 cannot follow the frequency and becomes non-polarized. Accordingly, the dielectric constant of the liquid crystal layer 124 can be varied by changing the frequency of the AC voltage applied to the second electrode 122. In this case, when the frequency of the AC voltage is high and the polarization of the liquid crystal molecule 126 cannot follow the frequency, this corresponds to the first state described above, and when the frequency of the AC voltage is low and the polarization of the liquid crystal molecule 126 can follow the frequency, this corresponds to the second state described above. In this manner, the phase shifter 104 can control the phase of the high frequency signal by applying an AC voltage to the second electrode 122 and varying its frequency.

The dielectric constant of the liquid crystal layer 124 varies depending on the temperature. Table 1 shows an example of a temperature-dependent dielectric constant in a nematic liquid crystal. The dielectric constant of the first dielectric constant (ε_{⊥}) in the first state does not vary in the range of 20° C., 40° C., and 60° C., whereas the second dielectric constant (ε_{//}) in the second state varies in the same temperature range. Table 1 also shows that the dielectric constant varies with the frequency (1 kHz, 20 GHz) of the AC voltage applied to the liquid crystal layer.

TABLE 1

| | | 20° C. | 40° C. | 60° C. |
|---|---|---|---|---|
| 20 GHz | ε_{⊥} | 2.50 | 2.50 | 2.50 |
| | ε_{//} | 3.00 | 2.95 | 2.85 |
| | [symbol] | 0.17 | 0.15 | 0.12 |
| 1 kHz | ε_{⊥} | 5.20 | 5.20 | 5.20 |
| | ε_{//} | 19.00 | 16.50 | 15.00 |
| | [symbol] | 0.73 | 0.68 | 0.65 |

As shown in Table 1, the dielectric constant of the liquid crystal layer 124 is constant with respect to temperature, whereas the first dielectric constant (ε_{⊥}) is constant with respect to temperature, and the second dielectric constant (ε_{//}) is varied with respect to temperature. Accordingly, it is possible to compensate for the temperature of the dielectric constant by adjusting the value of the control signal V_{LC} controlling the orientation state of the liquid crystal layer 124. Here, to perform temperature compensation for the dielectric constant of the liquid crystal layer 124, it is sufficient to control the tunability (τ_{eff}) defined in Eq. (1) to be constant.

τ_{eff}=(ε_{//}−ε_{⊥})/ε_{//} (1)

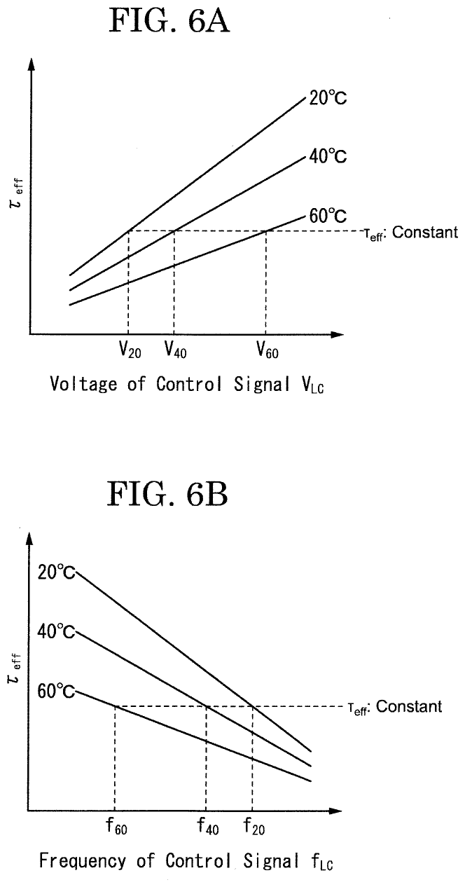

FIG. 6A is a graph schematically showing the relationship between the tunability of the liquid phase layer and the control signal V_{LC}. As shown in FIG. 6A, the dielectric constant depends on the temperature, even though the control signal V_{LC} applied to the liquid crystal layer 124 is constant. Accordingly, if temperature compensation is not considered, the amount of phase shift of the phase shifter 104 will vary depending on the temperature. Therefore, it is possible to compensate the temperature of the amount of phase shift by adjusting the control signal V_{LC} so that the tunability (τ_{eff}) becomes constant. For example, as shown in FIG. 6A, it is possible to keep the dielectric constant of the liquid crystal layer 124 constant by changing the control signal V_{LC} to V₂₀, V₄₀, and V₆₀ so that the tunability (τ_{eff}) becomes constant, and to suppress the variation of the amount of phase shift with temperature.

FIG. 6B is a graph schematically showing the relationship between the tunability of the liquid phase layer and the frequency of the control signal V_{LC} applied to the liquid crystal layer 124. As shown in FIG. 6B, the dielectric constant of the liquid crystal layer 124 varies depending on the temperature, even though the frequency f_{LC} of the control signal V_{LC} is constant. Accordingly, without temperature compensation, the amount of phase shift of the phase shifter 104 will vary depending on the temperature. Accordingly, by adjusting the frequency f_{LC} of the control signal V_{LC} so that the tunability (τ_{eff}) is constant, temperature compensation of the amount of phase shift can be performed. For example, as shown in FIG. 6A, by varying the frequency f_{LC} of the control signal V_{LC} with the f₆₀, f₄₀, and f₂₀ so that the tunability (τ_{eff}) is constant, the tunability of the liquid crystal layer 124 can be maintained constant and variations due to the temperature of the amount of phase shift can be suppressed.

Although the dielectric constant of the liquid crystal layer 124 varies due to a change in the orientation of the liquid crystal molecule 126, the capacitance formed between the first electrode 120 and the second electrode 122 also changes with a concomitant change. That is, the capacitance formed between the first electrode 120 and the second electrode 122 is greater in the second state than in the first state. Such characteristics can also be used to vary the resonant frequency of the antenna. That is, the resonant condition of the antenna can be variable.

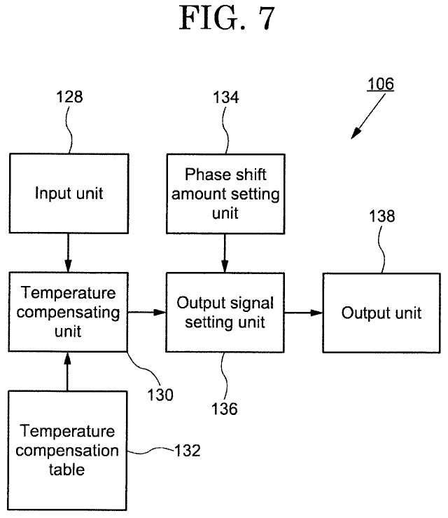

FIG. 7 shows an example of a configuration of the phase control circuit 106. As shown in FIG. 7, the phase control circuit 106 includes an input unit 128, a temperature compensation unit 130, a temperature compensation table 132, a phase shift amount setting unit 134, an output signal setting unit 136, and an output unit 138. The input unit 128 receives the output signal of the temperature sensor 108. The temperature compensation unit 130 reads out the compensation data from the temperature compensation table 132 based on the temperature data input to the input unit 128 and reads out the temperature compensation data so that the tunability (τ_{eff}) is constant as described above. The phase shift amount setting unit 134 sets the control signal V_{LC0} for controlling the amount of phase shift of the phase shifter 104 corresponding to each antenna element 102. The control signal V_{LC0} set by the phase shift amount setting unit 134 is the default value before the temperature compensation is performed. The output signal setting unit 136 computes and processes the control signal V_{LC0} and the temperature compensation data to set the control signal V_{LC}. The output unit 138 outputs the set control signal V_{LC} to the phase shifter 104.

Although the above shows the case where the control signal V_{LC} is a DC voltage, the same applies to the case where the AC control signal V_{LC} is applied. In this case, the output signal setting unit 136 sets the frequency f_{LC} of the control signal V_{LC} based on the temperature compensation data.

The phased array antenna 100 according to one embodiment of the present invention includes the phase control circuit 106 that outputs a control signal for controlling the amount of phase shift of the phase shifter 104. The phase control circuit 106 outputs a control signal based on the temperature of the phase shifter 104 sensed by the temperature sensor 108. Accordingly, radio waves with a precisely controlled phase from the antenna element array 103 can be stably output regardless of the ambient temperature.

What is claimed is:

1. A phased array antenna, comprising:
a plurality of antenna elements;
a plurality of phase shifters, each of the plurality of phase shifters is connected to each of the plurality of antenna elements, respectively;
a phase control circuit for controlling the amount of phase shift of the plurality of phase shifters; and
a temperature sensor for detecting the temperature of the plurality of phase shifters,
wherein the phase control circuit is configured to control a voltage applied to the plurality of phase shifters based on the temperature detected by the temperature sensor.

2. The phased array antenna according to claim 1, wherein each of the plurality of phase shifters includes a first electrode, a second electrode facing the first electrode to form a strip line, and a liquid crystal layer between the first electrode and the second electrode.

3. The phased array antenna according to claim 2, wherein the liquid crystal material of the liquid crystal layer is one kind selected from nematic liquid crystal, smectic liquid crystal, cholesteric liquid crystal, discotic liquid crystal and ferroelectric liquid crystal.

4. The phased array antenna according to claim 1, wherein the temperature sensor is configured to detect the temperature of at least one or all of the plurality of phase shifters.

5. The phased array antenna according to claim 1, wherein the temperature sensor is configured to detect the temperature of the environment in which the plurality of phase shifters is disposed.

6. The phased array antenna according to claim 1, wherein the temperature sensor is disposed in contact with at least one of the plurality of phase shifters.

7. The phased array antenna according to claim 1, wherein the phase control circuit is configured to adjust a control signal applied to each of the plurality of phase shifters based on a temperature detected by the temperature sensor.

8. The phased array antenna according to claim 1, wherein the phase control circuit is configured to adjust the frequency of a control signal applied to each of the plurality of phase shifters based on the temperature detected by the temperature sensor.

9. The phased array antenna according to claim 2, wherein the phase control circuit is configured to adjust the potential of a control signal applied to the second electrode based on the temperature detected by the temperature sensor.

10. The phased array antenna according to claim 2, wherein the phase control circuit is configured to adjust the frequency of a control signal applied to the second electrode based on the temperature detected by the temperature sensor.
